(19) United States
(12) Patent Application Publication
(10) Pub. No.: US 2011/0126391 A1
(43) Pub. Date: Jun. 2, 2011

(54) HAND TOOL FOR GUIDING WORKPIECE DURING FLOOR INSTALLATION

(75) Inventors: Kenneth Biktjorn, Middletown, NY (US); Espen Vige, Chester, NY (US)

(73) Assignee: Floormaster Systems, Inc., Chester, NY (US)

(21) Appl. No.: 12/628,545

(22) Filed: Dec. 1, 2009

(51) Int. Cl. B23Q 3/00

(52) U.S. Cl. 29/283

(57) ABSTRACT

A hand tool for guiding a workpiece into a position during installation of the workpiece comprises a handle having an elongated shaft and a strike block fastened to the elongated shaft. The strike block includes an impact surface, a flange coupled to the impact surface to distribute a force applied to the impact surface to the workpiece, and a ledge extending generally perpendicular to the flange and seatable upon the workpiece.

### FIELD OF THE INVENTION

The present invention relates to a hand tool and in particular, the present invention relates to the hand tool for guiding a workpiece into a position during installation of the workpiece.

### BACKGROUND OF THE INVENTION

Various hand tools have been designed and used for guiding workpieces such as slabs or tiles made of wood, stone or other suitable materials into a desired position while installing them onto surfaces such as floors. Common examples of such hand tools are hammers and mallets. Typically, during an installation, the workpieces need to be aligned with adjacent workpieces using such hand tools. Improper distribution of force on the workpieces arising from the usage of such hand tools can lead to damage or breakage of a workpiece or misalignment of a workpiece. Replacement and reinstallation of such a workpiece can be time consuming. This leads to waste of workpieces and an increase in the general cost of installation and labor involved.

In light of the foregoing limitations, there exists a need for an improved hand tool for guiding the workpiece into position.

### SUMMARY OF THE INVENTION

In accordance with one aspect of the invention, an apparatus is provided for guiding a workpiece into position during installation. The apparatus comprising a handle having an elongated shaft and a strike block fastened to the elongated shaft. The strike block includes an impact surface, a flange coupled to the impact surface to distribute a force applied to the impact surface to the workpiece, and a ledge extending generally perpendicular to the flange and seatable upon the workpiece.

Optionally, an apparatus described can include further features. For example, the impact surface can comprise a dampener such as a hard plastic seated partially within the strike block. The flange and the ledge can define a seat for receiving the workpiece therein, with the seat having a dimension generally commensurate with one dimension of the workpiece.

These and other aspects, features and advantages of the invention can be further appreciated from the accompanying drawing figures and description of certain embodiments of the invention.

### BRIEF DESCRIPTION OF THE DRAWINGS

FIG. 1 illustrates a hand tool in accordance with an embodiment of the invention.

FIG. 2 is a close-up view of a strike block of the hand tool of FIG. 1.

FIG. 3 is a detailed side view of the strike block of FIG. 1.

### DETAILED DESCRIPTION OF CERTAIN EMBODIMENTS OF THE INVENTION

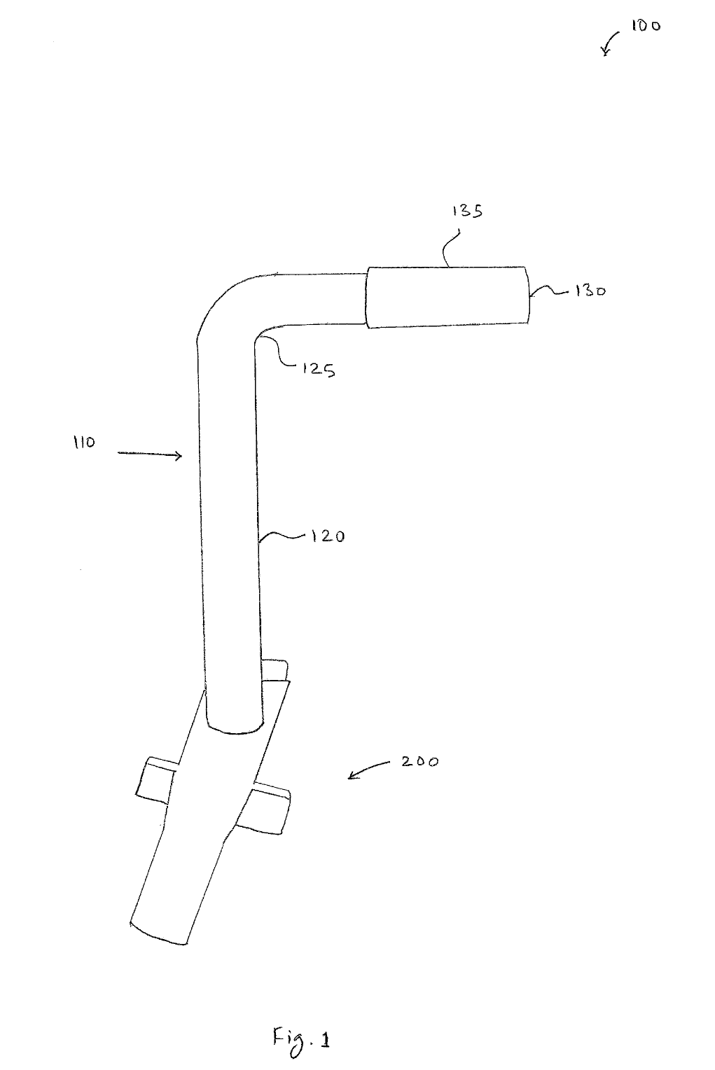

Embodiments of the invention described herein are generally directed to a hand tool 100 for guiding a workpiece into a position during installation of the workpiece, is shown in FIGS. 1-3. The hand tool 100 includes a handle 110 having an elongated shaft 120. The handle is connected to a strike block 200 at one end of the elongated shaft. In a particular embodiment of the invention, the handle includes a grip portion 130 disposed at an opposing end of the elongated shaft. The grip portion provides a comfortable and secure grip to securely hold the hand tool. For example, the grip portion can be arranged so as to be included on and connected to the elongated shaft by way of a bend 125. The bend can be substantially perpendicular to the elongated shaft, as shown. The elongated shaft and the grip portion form a unitary construction in the illustrated embodiment. The bend can be of a certain angle that makes the hand tool design user friendly by facilitating the user to hold the hand tool at the grip portion more conveniently when standing next to the hand tool in an upright position.

In the illustrated embodiment of the invention, the grip portion 130 is surrounded by a cover 135 to provide a cushioned grip while operating the hand tool 100. The cover surrounding the grip portion in one exemplary form can be made up of a cushion material such as a rubber; however, it will be appreciated that the cushion material, if provided at all, can be any number of other forms, including but not limited to a foam, a wood, a plastic and the like. The grip portion can aid the user to hold the hand tool with one hand and swing a striking apparatus with the other hand to strike the strike block 200. The striking apparatus typically can be a mallet, a hammer or the like, but forms no part of the present invention.

In an alternative arrangement, the handle 110 can have the grip portion 130 positioned perpendicularly to the elongated shaft 120 without the bend 125. This arrangement can be a result of the angle between the grip portion and the elongated shaft renders a clearer view of the strike block 200 and the workpiece to the user. It also aids to a tighter grip on the grip portion.

In an alternative embodiment, the handle 100 can be telescopic. The telescopic handle can be adjusted to increase or decrease the height of the handle with respect to the strike block 200 by adjusting the length of the elongated shaft 120 to suit user requirements, such as to accommodate users of different height.

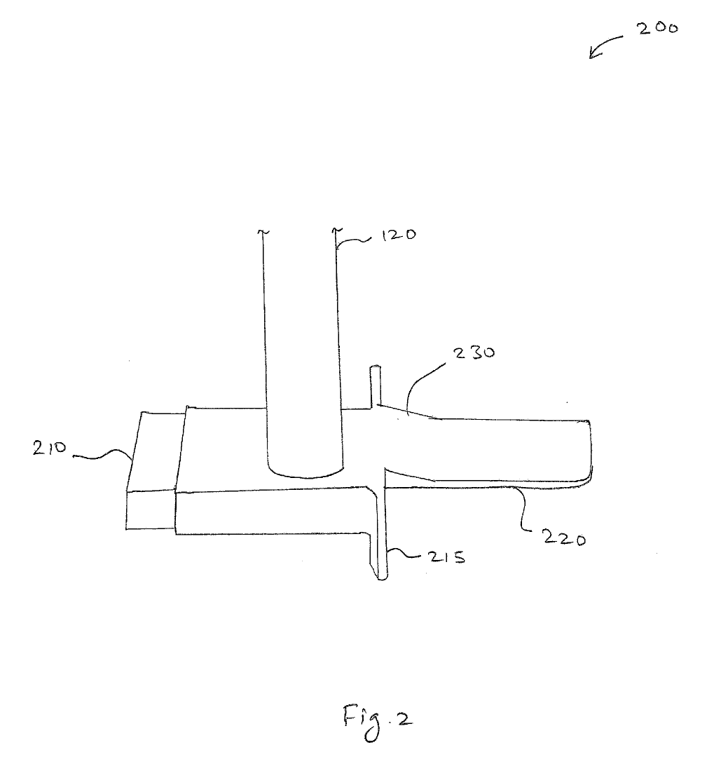

FIG. 2 illustrates further details of the strike block 200 of the hand tool 100 of FIG. 1. The strike block is fastened to the elongated shaft 120. It can be appreciated that the strike block can be fastened to the elongated shaft in a number of conventional ways including but not limited to welding, attached with screws or rivets and the like. The strike block can be detachably fastened to the elongated shaft and different shape or size strike blocks can be attached to suit a particular workpiece or work environment.

The strike block includes an impact surface 210, flange 215 and a ledge 220. In the illustrated embodiment, the flange and ledge can be solid blocks made of a metal or an alloy.

While a workpiece is being installed, the strike block 200 is positioned such that the flange 215 skirts a portion of the workpiece with the ledge 220 sitting substantially flat on an upper surface of the workpiece. A striking apparatus such as a mallet or a hammer is then used to apply an impact force to the impact surface 210 to move and guide the workpiece into a desired position. The flange is typically coupled to the impact surface for distributing the impact force applied to workpiece. This distribution of the impact force over the side of the workpiece better protects the workpiece against damage or breakage during installation. For instance, the flange can comprise projections extending substantially laterally away from the strike block.

The flange 215 can provide stability to the hand tool 100 so that the hand tool 100 does not fall over while unattained and in an upright position. Optionally, a cushion can be disposed on a portion of the flange to protect the workpiece from damage.

The impact surface 210 can include a damper to minimize mechanical vibrations upon striking the strike block 200. The damper can be made of any suitable cushioning material such as a plastic, rubber, wood, hard form and the like. Optionally, the impact surface can be recessed into the strike block. Any user operating the hand tool 100 hits the impact surface using the striking apparatus to achieve the desired result of aligning or adjusting the workpiece.

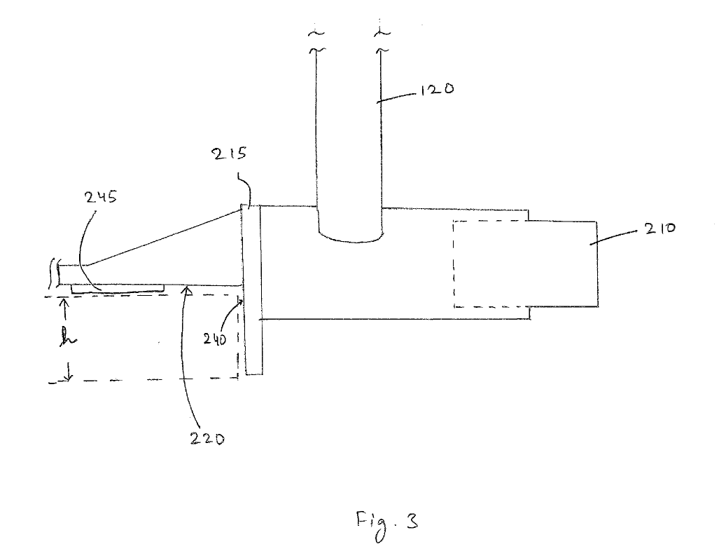

Referring now to FIG. 3, the ledge 220 extends generally perpendicular to the flange 215 and is seatable upon the workpiece. The combination of the flange and the ledge defines a seat 240 for receiving the workpiece. The seat has a dimension generally commensurate with one of the dimensions of the workpiece. As shown, the seat is generally commensurate with a height h of the workpiece. The ledge along with the flange helps to support the workpiece and hold it in place while installation. In the illustrated embodiment, the ledge has a surface shaped to complement the workpiece (e.g., it is straight). In an alternate embodiment, a cushion 245 is disposed on at least a portion of the ledge that faces the workpiece that allows the hand tool 100 to make soft contact with any kind of workpiece and better prevents damage to the workpiece. In the illustrated embodiment, a slant support 230 extending from a portion of the flange and connecting the ledge with the flange is configured to provide additional rigidity to the ledge.

It should be observed that a hand tool part and component have been represented by conventional symbols in the drawings, showing only specific details that are relevant for an understanding of the present disclosure. Further, details that may be readily apparent to person ordinarily skilled in the art may not have been disclosed.

While the invention has been described in connection with what are presently considered to be the most practical and various embodiments, it is to be understood that the invention is not to be limited to the disclosed embodiments, but on the contrary, is intended to cover various modifications and equivalent arrangements included within the spirit and scope of the appended claims.

What is claimed is:

1. An apparatus for guiding a workpiece into a position during installation, comprising:
a handle having an elongated shaft;
a strike block fastened to the elongated shaft and having:
an impact surface;
a flange coupled to the impact surface to distribute a force applied to the impact surface to the workpiece; and
a ledge extending generally perpendicular to the flange and seatable upon the workpiece.

2. The apparatus of claim 1, wherein the flange includes at least one projection extending laterally away from the strike block.

3. The apparatus of claim 1, wherein the impact surface comprises a dampener.

4. The apparatus of claim 3, wherein the dampener is a hard plastic seated partially within the strike block.

5. The apparatus of claim 1, wherein the flange and the ledge define a seat for receiving the workpiece therein.

6. The apparatus of claim 5, wherein the seat has a dimension generally commensurate with one dimension of the workpiece.

7. The apparatus of claim 1, wherein the ledge has a surface shaped to complement the workpiece.

8. The apparatus of claim 1, wherein the ledge has a width less than a width of the flange.

9. The apparatus of claim 1, wherein the shaft includes a bend.

10. The apparatus of claim 1, wherein the handle is telescopic.

11. The apparatus of claim 1, wherein the handle includes a cover.

12. The apparatus of claim 11, wherein the handle further having a grip portion extending at an angle at the elongated shaft.

13. The apparatus of claim 12, wherein the elongated shaft and the grip portion form a unitary construction.

14. The apparatus of claim 1, wherein the strike block is detachably fastened to the elongated shaft.

15. The apparatus of claim 1, further comprising a cushion disposed on at least a portion of the flange.

16. The apparatus of claim 1, further comprising a cushion disposed on at least a portion of the ledge so as to make contact with any workpiece.

17. The apparatus of claim 1, wherein the strike block is made of a single material.

18. An apparatus for guiding a workpiece into a position during installation, comprising:
a handle having first and second shaft portions configured at an angle to each other;
a strike block fastened to the second shaft portion and having:
an impact surface;
a flange coupled to the impact surface to distribute a force applied to the impact surface to the workpiece; and
a ledge extending generally perpendicular to the flange and seatable upon the workpiece,
whereby a seat is defined between the flange and the ledge for receiving the workpiece therein, the seat having a dimension generally commensurate with one dimension of the workpiece.

19. The apparatus of claim 18, wherein the impact surface comprises a dampener.

20. The apparatus of claim 18, wherein the flange and the ledge define a seat for receiving the workpiece therein.
